(19) United States
(12) Patent Application Publication
(10) Pub. No.: US 2025/0091302 A1
(43) Pub. Date: Mar. 20, 2025

(54) PROCESS FOR THE MANUFACTURE OF HOLLOW MANUFACTURED ARTICLES MADE OF COMPOSITE MATERIAL

(71) Applicant: Massimiliano LAPIANA, Modena (MO) (IT)

(72) Inventor: Massimiliano LAPIANA, Modena (MO) (IT)

(21) Appl. No.: 18/294,455

(22) PCT Filed: Aug. 3, 2022
(86) PCT No.: PCT/IB2022/057206

§ 371 Date: Feb. 1, 2024

(30) Foreign Application Priority Data
Aug. 4, 2021 (IT) 102021000021119

(51) Int. Cl. B29C 70/44; B29L 22/00

(52) U.S. Cl. CPC B29C 70/44; B29L 2022/00

(57) ABSTRACT

A process for the manufacture of hollow manufactured articles made of composite material comprises: at least one phase of supply of a composite material for the manufacture of a manufactured article provided with one or more cavities; at least one phase of supply of at least one die body; at least one phase of supply of at least one mould provided with at least two valve bodies pressable under pressure against each other in order to define, interposed between the same bodies, at least one groove; at least one phase of arranging said die body inside said groove; at least one phase of interposing said composite material between said die body and said mould, inside said groove; and at least one phase of curing the composite material contained in said groove.

### TECHNICAL FIELD

The present invention relates to a process for the manufacture of hollow manufactured articles made of composite materials.

### BACKGROUND ART

A variety of manufacturing processes of hollow manufactured articles are known that employ composite materials, suitably machined and shaped, to make particularly light and strong manufactured articles which, by virtue of their characteristics, find application in many technical fields.

In general, this type of process combines two or more constituent materials, having physical/mechanical properties different from each other, to make a composite material used in turn to make a manufactured article with superior physical/mechanical properties compared to those of the starting constituent materials.

Specifically, composite materials comprise at least one first constituent material, the so-called reinforcement, which has the aim of providing strength and stiffness to the final manufactured article and at least one second constituent material, the so-called die, which has the aim of operating as a filler material and of adhering to the reinforcement in order to provide stability and geometry to the final manufactured article.

Commonly, this type of process subjects the manufactured article to high-pressure and high-temperature processes that allow the composite material to polarize, so as to give the manufactured article particular strength.

Advantageously, by means of certain molding processes, such as autoclave processes by means of disposable bag and/or Resin Transfer Molding (RTM) processes, the processes of known type enable manufactured articles made of composite material of the hollow type to be made.

This type of process does however have some drawbacks.

In particular, only a particularly limited number of constituent materials can be used to make manufactured articles of the hollow type by means of the processes of known type.

In fact, not all constituent materials allow for hollow-geometry manufactured articles to be made capable, given their conformation, of withstanding the pressures and temperatures to which they are subjected by the processes of known type.

On the other hand, the reduction in pressure and temperature would ensure an insufficient degree of curing of the composite material and significantly limit the strength of the manufactured products and their fields of application.

In addition, the processes of known type are particularly complex and expensive.

### DESCRIPTION OF THE INVENTION

The main aim of the present invention is to devise a process which allows employing any constituent material to make the hollow manufactured articles made of composite materials.

Another object of the present invention is to devise a process which allows the composite material for the manufacture of hollow manufactured articles to be subjected to higher pressures and/or temperatures than those applied by the processes of known type regardless of the composite material used.

A further object of the present invention is to devise a process for the manufacture of hollow manufactured articles made of composite materials that is particularly inexpensive compared to the processes of known type.

An additional object of the present invention is to devise a process for the manufacture of hollow manufactured articles made of composite materials that is simple and easy to make compared to the processes of known type.

Another object of the present invention is to devise a process for the manufacture of hollow manufactured articles made of composite materials that can overcome the aforementioned drawbacks of the prior art within the framework of a simple, rational, easy-to-use and cost-effective solution.

The aforementioned objects are achieved by the present process for the manufacture of hollow manufactured articles made of composite materials having the characteristics of claim 1.

The aforementioned objects are achieved by this system for the manufacture of hollow manufactured articles made of composite materials having the characteristics of claim 8.

### BRIEF DESCRIPTION OF THE DRAWINGS

Other characteristics and advantages of the present invention will become more apparent from the description of a preferred, but not exclusive, embodiment of a process for the manufacture of hollow manufactured articles made of composite materials, illustrated by way of an indicative, yet non-limiting example, in the accompanying tables of drawings in which:

FIG. 1 is an axonometric view of some components of the system used to execute the process according to the invention;

FIG. 2 is an exploded view of some components of the system used to execute the process according to the invention;

FIGS. 3-5 are views of some components of the system at distinct stages of the process according to the invention.

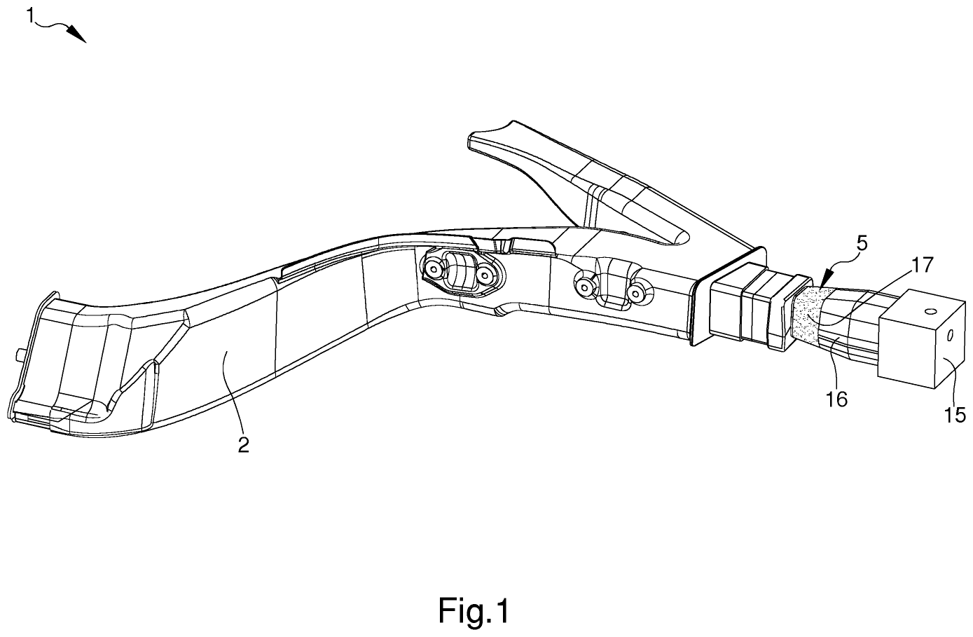

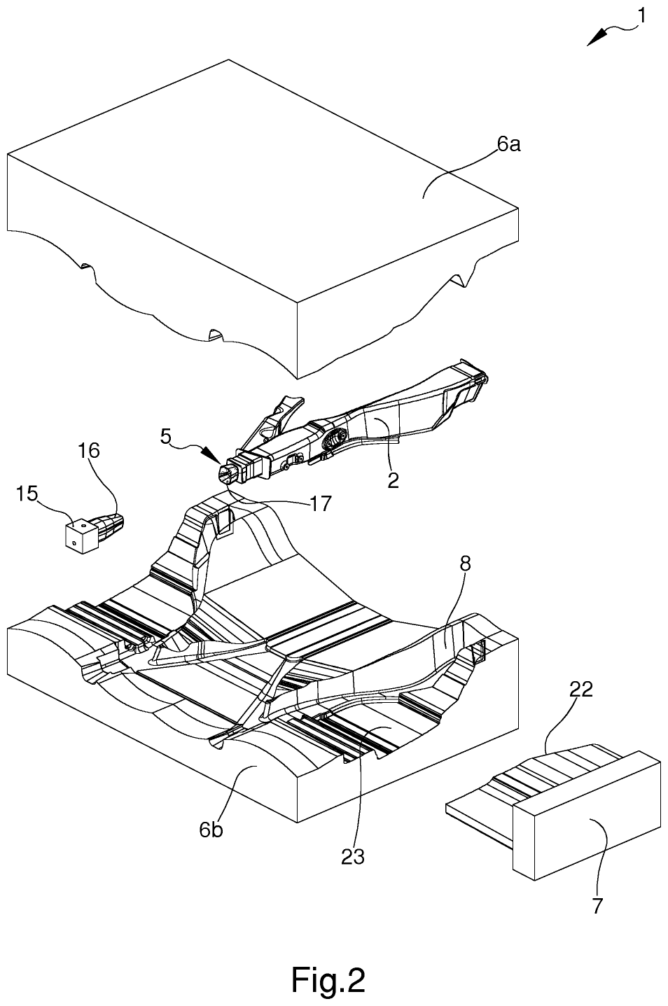

### EMBODIMENTS OF THE INVENTION

The process for the manufacture of hollow manufactured articles made of composite materials comprises:
at least one phase of supply of at least one composite material 2 for the manufacture of a manufactured article 3 provided with one or more cavities 4;
at least one phase of supply of at least one die body 5 having a conformation substantially equal to that of the manufactured article 3 to be made;
at least one phase of supply of at least one mould 6a, 6b, 7 provided with at least two valve bodies 6a, 6b pressable under pressure against each other in order to define, interposed between the same bodies 6a, 6b, at least one groove 8 having a substantially complementary conformation to that of the manufactured article 3 to be made;
at least one phase of arranging the die body 5 inside the groove 8;
at least one phase of interposing the composite material 2 between the die body 5 and the mould 6a, 6b, 7, inside the groove 8;
at least one phase of curing the composite material 2 contained in the groove 8, comprising at least one step of pressing the bodies 6a, 6b against each other in order to close the mould 6a, 6b, 7 at least partly around the die body 5, by pressing the composite material 2 under pressure between the die body 5 and the bodies 6a, 6b.

Conveniently, the composite material 2 comprises at least one first constituent material selected from the list comprising: organic and non-organic polymeric materials, metallic materials, ceramic materials and the like.

Appropriately, the composite material 2 comprises at least one second constituent material selected from the list comprising: glass fiber, carbon fiber, aramid fiber, boron fiber, silicon carbide fibers and the like.

Advantageously, the phase of supply of the die body 5 comprises at least one step of making the same by means of a molding process of at least one material to be machined, preferably of the thermoplastic type or the like, to make the die body 5.

Specifically, the step of manufacturing comprises a step of modeling the material to be machined which involves giving the material itself, i.e., the die body 5, the conformation of the manufactured article 3 to be manufactured.

According to a preferred, but not exclusive, embodiment of the process, the step of manufacturing the die body 5 is carried out by means of a Blow Molding process. In this way, the die body 5 is made substantially hollow.

Appropriately, the process comprises at least one phase of laminating the composite material 2 around the die body 5 to give the composite material 2 the conformation of the manufactured article 3.

In other words, the process involves employing the die body 5 as a spindle which, in this way, transfers its conformation to the composite material 2. In other words, the die body 5 shapes the composite material 2 which, in this way, defines the cavity 4 of the manufactured article 3 to be made.

In fact, following the phase of laminating, the cavity 4 defined by the composite material 2 is occupied by the die body 5 to size.

Specifically, the phase of laminating comprises at least one step of introducing at least one pressurized operating fluid inside the die body 5.

Preferably, the operating fluid is a fluid of the compressible type. Further embodiments of the process cannot however be ruled out wherein the operating fluid is of the incompressible type.

Preferably, the operating fluid is air, water or similar fluids.

In this way, the step of introducing gives rigidity to the die body 5 and facilitates the execution of the phase of laminating.

Advantageously, the process according to the invention comprises at least one phase of testing the composite material 2 for tightness, comprising at least one step of introducing at least one test fluid under pressure into the composite material 2 having the conformation of the manufactured article 3.

Preferably, the test fluid is a fluid of the compressible type. However, further embodiments of the process wherein the test fluid is of the incompressible type cannot be ruled out.

The test fluid preferably coincides with the operating fluid.

Preferably, the test fluid is air, water or similar fluids.

In particular, the testing phase is carried out following the phase of laminating and, preferably, before the phase of curing.

In this way, the process makes it possible to check for the tightness of the composite material 2, shaped as the manufactured article 3 to be made, before carrying out the phase of curing and thus avoiding waste. In fact, this expedient allows the process to avoid the execution of a phase of curing on a composite material 2 that does not meet the desired tightness requirements.

Preferably, the process according to the invention involves arranging the die body 5 inside the groove 8 after the tightness testing phase.

Conveniently, the phase of arranging the die body 5 and the phase of interposing the composite material 2 coincide with each other.

In fact, preferably following the phase of laminating, the composite material 2 is arranged inside the groove 8 at the same time as the arrangement of the die body 5 inside the same groove.

Preferably, the process according to the invention involves carrying out the phase of curing after the phase of interposing.

Advantageously, the phase of curing comprises at least one step of filling the die body 5 with at least one working fluid under pressure.

Preferably, the working fluid is a fluid of the compressible type. Further embodiments of performing the process cannot however be ruled out wherein the working fluid is of the incompressible type.

The working fluid preferably coincides with the operating fluid.

Preferably, the working fluid is air, water, hydraulic oil or similar fluids.

In this way, the die body 5 counteracts from the inside of the cavity 4 the pressure exerted by the mould 6a, 6b, 7 on the composite material 2.

In fact, the die body 5 operates from the inside of the cavity 4 on the inner walls of the composite material 2, while the mould 6a, 6b, 7 operates from the outside of the cavity 4 on the outer walls of the composite material 2.

In other words, the die body 5 and the mould 6a, 6b, 7 substantially operate in a vice fashion on the composite material 2.

This expedient preserves the soundness of the conformation and of the geometry of the composite material 2, particularly of its cavity or cavities 4, and consequently also of the manufactured article 3 it makes.

In fact, the effect of the working fluid under pressure inside the die body 5 allows the composite material 2 to maintain its shape without undergoing deformation under the effect of the pressure exerted by the mould 6a, 6b, 7.

In particular, this expedient allows the composite material 2 to be subjected to extremely high pressures, so that, regardless of the composite material 2 used, a high degree of curing of the same is ensured. Consequently, this expedient allows for the simple, inexpensive and fast manufacturing of the manufactured articles 3 having complex/articulated conformations and geometries, e.g., defining one or more cavities 4.

Appropriately, the step of filling the die body 5 is carried out prior to the step of pressure of the bodies 6a, 6b. In addition, the working fluid is kept under pressure inside the die body 5 substantially during the whole execution of the step of pressure.

Conveniently, the phase of curing comprises at least one step of heating the mould 6a, 6b, 7.

Advantageously, the phase of heating facilitates the curing of the composite material 2.

In particular, the phase of heating is carried out throughout the execution of the step of pressure.

In fact, the combination of the phase of heating and the step of pressure further facilitates the curing of the composite material 2.

Preferably, at the end of the phase of curing, the process according to the invention involves a phase of extracting the manufactured article 3 from the mould 6a, 6b, 7.

In addition, the process comprises at least one phase of extracting the working fluid from the die body 5.

Advantageously, the phase of extracting is carried out during or after the phase of extracting the manufactured article 3.

Appropriately, the process comprises at least one phase of reducing the internal pressure of the die body 5 to the point of causing it to contract upon itself.

Preferably, the phase of reducing the internal pressure of the die body 5 involves substantially making the vacuum inside the die body 5.

In this way, the die body 5 collapses at least partly on itself and is detached from the inner walls of the manufactured article 3. This expedient allows the die body 5 to be easily extracted from the cavity 4.

The present invention relates to a system 1 for the manufacture of hollow manufactured articles made of composite material according to the process described above.

In particular, what has been described about the die body 5, the mould 6a, 6b, 7, the composite material 2 and the manufactured article 3 with reference to the above-described process is to be considered completely or at least partly valid with reference to the system 1.

The system 1 for the manufacture of hollow manufactured articles made of composite material comprises:
at least one die body 5 having a conformation substantially the same as that of a manufactured article 3 which is provided with one or more cavities 4 and to be made at least partly of composite material 2;
at least one mould 6a, 6b, 7 provided with at least two valve bodies 6a, 6b pressable under pressure against each other in a working configuration wherein the same mould is closed and defines, interposed between the bodies 6a, 6b, at least one groove 8 having a conformation substantially complementary to that of the manufactured article 3 to be made and housing the die body 5 and the composite material 2, the composite material 2 being pressed under pressure between the die body 5 and the bodies 6a, 6b in the working configuration to make the manufactured article 3.

Specifically, the die body 5 comprises at least one outer lateral surface 24 having a conformation substantially the same as the outer lateral surface of the manufactured article 3 to be made.

In more detail, the die body 5 is adapted to be wrapped by the composite material 2 and to give it the conformation of the manufactured article 3 to be made.

In fact, preferably, the die body 5 is used for the execution of the phase of laminating.

Moreover, in this way, the cavity 4 is defined by effect of the die body 5.

In particular, the cavity 4 has a conformation substantially complementary to the conformation of the die body 5.

In addition, in the working configuration, the die body 5 counteracts the pressure exerted by the bodies 6a, 6b on the composite material 2 as previously described with reference to the process according to the invention.

Advantageously, the die body 5 is at least partly hollow.

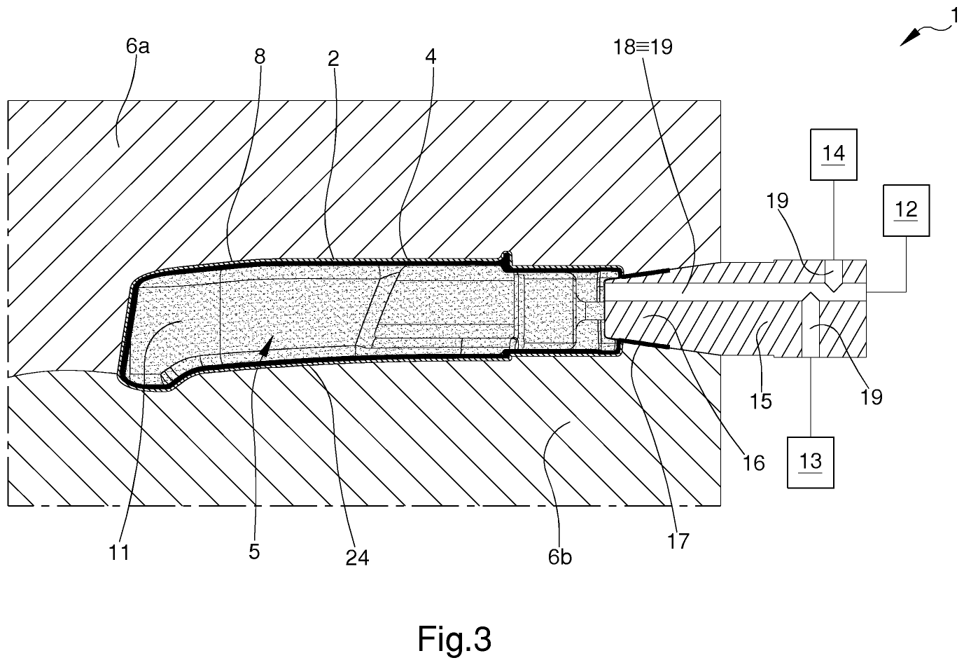

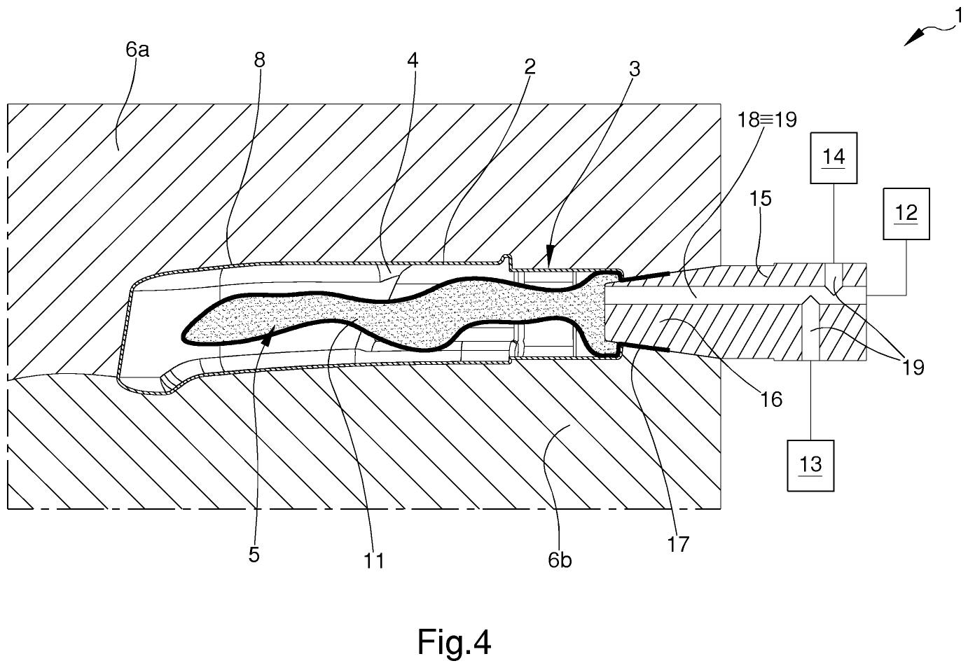

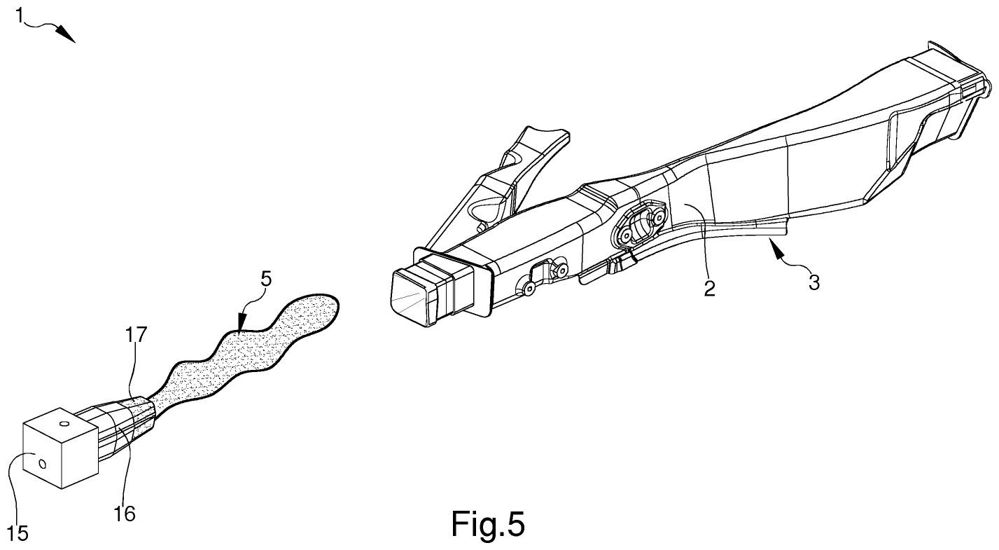

In fact, the die body 5 defines at least one void 11 within it, as shown in FIG. 3.

In addition, the die body 5 is made of at least partly deformable and/or elastically deformable material.

Conveniently, the system 1 comprises at least one connecting element 15 of the die body 5 to at least one of:
input means 12 of at least one working fluid under pressure into the die body 5;
extraction means 13 of the working fluid from the die body 5;
reduction means 14 of the internal pressure of the die body 5 to the point of causing it to contract upon itself.

Advantageously, the system 1 comprises at least one of the input means 12, the extraction means 13 or the reduction means 14.

According to the invention, the input means 12 are used to carry out the step of introducing and/or the testing phase and/or the input phase.

The extraction means 13, on the other hand, are used to carry out the phase of extraction.

The reduction means 14, on the other hand, are used to carry out the phase of reduction.

Preferably, at least one of either the input means 12 or the extraction means 13 are of the type of air-operated/hydraulic means configured to introduce under pressure and/or to extract the working fluid from the die body 5.

The reduction means 14 are, preferably, of the type of air-operated means configured to extract air from the inside of the die body 5.

Preferably, the connecting element 15 is employed for the execution of at least one of the step of introduction, the testing phase, the phase of input, the phase of extraction and the phase of reduction.

Specifically, the connecting element 15 is employed for the execution of the step of introduction, the phase of testing, the input phase, the phase of extraction and the phase of reduction.

Preferably, the connecting element 15 can be coupled to the die body 5 in a removable manner so that at least one of the input means 12, the extraction means 13 and the reduction means 14 can be connected to the die body 5.

Specifically, the connecting element 15 connects the input means 12, the extraction means 13 and the reduction means 14 to the die body 5.

According to the invention, the system 1 comprises at least a first coupling portion 16, made on the die body 5, and at least a second coupling portion 17, made on the connecting element 15 and coupleable to the first coupling portion 16 in a removable manner to enable the connection of at least one of the input means 12, the extraction means 13 or the reduction means 14 to the die body 5. Preferably, one of either the first or the second coupling portions 16, 17 is of the type of an access opening and the other of either the first or the second coupling portions 16, 17 is of the type of a protruding portion which is insertable in a removable manner in the access opening.

In addition, preferably, the access opening is made on the die body 5 and the protruding portion is made on the connecting element 15.

Conveniently, the connecting element 15 defines a plurality of connecting ways 18, 19, each connected to the die body 5 and to at least one of the input means 12, the extraction means 13 or the reduction means 14.

Preferably, the connecting element 15 is of the type of a multi-way valve.

According to a preferred, but not exclusive, embodiment of the system 1, the connecting element 15 comprises:
at least one common way 18 connected, in use, to the die body 5;
a plurality of connecting ways 19 to the common way 18, each of the connecting ways 19 being connected to one of the input means 12, the extraction means 13 or the reduction means 14, respectively.

Specifically, the connecting element 15 comprises a connecting way 19 connected to the input means 12 and coincident with the common way 18, a connecting way 19 connected to the extraction means 13 and to the common way 18 and a connecting way 19 connected to the reduction means 14 and to the common way 18, as shown in FIG. 3.

In this way, the system 1 enables the execution of the step of introducing, the testing phase, the input phase, the phase of extraction and the phase of reduction with a single connecting element 15.

Conveniently, the system 1 comprises heating means, not shown in the figures, of the mould 6a, 6b, 7.

The heating means are preferably of the type of thermal power plants that employ a fluid, such as e.g. steam or diathermic oil, to heat the system 1.

In other words, the temperature means are configured to send the system 1 to temperature.

Preferably, the heating means are built into the mould 6a, 6b, 7.

Specifically, the heating means are connected to at least one of the valve bodies 6a, 6b and are configured to heat at least one of them.

In fact, preferably, the heating means are used to carry out the phase of heating. Preferably, in the working configuration, at least one of the bodies 6a, 6b of the mould 6a, 6b, 7 defines at least one access opening 23 to the groove 8. In addition, the mould 6a, 6b, 7 comprises at least one pressing body 7 having a substantially complementary conformation with respect to the access opening 23 and provided with at least one pressing face 22 facing inside the groove 8 in the working configuration.

Specifically, the pressing face 22, in use, preferably during the step of pressure, presses against the composite material 2 under pressure.

In fact, the pressing face 22 defines at least one template, not shown in the figures, adapted to shape the portion of the composite material 2 with which it gets in contact.

It has in practice been ascertained that the described invention achieves the intended objects.

In particular, the fact is emphasized that the use of the die body allows for the manufacture of manufactured articles from any composite material.

In addition, the use of the die body allows for higher pressures and/or temperatures to be applied to the composite material used to make hollow manufactured articles than those applied by the processes of known type regardless of the composite material used.

Advantageously, the use of the die body enables a particularly inexpensive and/or simple process for the manufacture of hollow manufactured articles made of composite material compared with the processes of known type.

1) A process for manufacture of hollow manufactured articles, the process comprising:
at least one phase of supply of a composite material for the manufacture of a manufactured article provided with one or more cavities (4);
at least one phase of supply of at least one die body having a conformation substantially equal to that of the manufactured article to be made;
at least one phase of supply of at least one mould provided with at least two valve bodies pressable under pressure against each other in order to define, interposed between the same bodies, at least one groove having a substantially complementary conformation to that of the manufactured article to be made;
at least one phase of arranging said die body inside said groove;
at least one phase of interposing said composite material between said die body and said mould, inside said groove and
at least one phase of curing the composite material contained in said groove, comprising at least one step of pressing said bodies against each other in order to close said mould at least partly around said die body, by pressing said composite material under pressure between said die body and said bodies.

2) The process according to claim 1, wherein said phase of curing comprises at least one step of filling said die body with at least one working fluid under pressure.

3) The process according to claim 1, wherein said phase of curing comprises at least one step of heating said mould.

4) The process according to claim 1, further comprising: at least one phase of reducing the internal pressure of said die body to the point of causing said die body to contract upon the die body itself.

5) The process according to claim 1, wherein said phase of arranging said die body and said phase of interposing said composite material coincide with each other.

6) The process according to claim 1, further comprising: at least one phase of laminating said composite material around said die body to give said composite material the conformation of said manufactured article.

7) The process according to claim 1, further comprising: at least one phase of testing said composite material for tightness, and at least one step of introducing at least one test fluid under pressure into said composite material having the conformation of said manufactured article.

8) A system for manufacture of hollow manufactured articles, the system comprising:
at least one die body having a conformation substantially the same as that of a manufactured article which is provided with one or more cavities and to be made at least partly of composite material;
at least one mould provided with at least two valve bodies pressable under pressure against each other in a working configuration wherein the same mould is closed and defines, interposed between said bodies, at least one groove having a conformation substantially complementary to that of the manufactured article to be made and housing said die body and the composite material, said composite material being pressed under pressure between said die body and said bodies in said working configuration to make said manufactured article.

9) The system according to claim 8, wherein said die body is made of at least partly deformable and/or elastically deformable material.

10) The system according to claim 8, wherein said die body is at least partly hollow and said system further comprising at least one connecting element of said die body to at least one of:
input means of at least one working fluid under pressure into said die body;
extraction means of said working fluid from said die body;
reduction means of the internal pressure of said die body to the point of causing said die body to contract upon the die body itself.

11) The system according to claim 10, wherein said connecting element defines a plurality of connecting ways, each connected to said die body and to at least one of said input means, said extraction means or said reduction means.

12) The system according to claim 8, further comprising: heating means of said mould.
